(19) United States
(12) Patent Application Publication
(10) Pub. No.: US 2026/0349201 A1
(43) Pub. Date: Nov. 5, 2026

(54) FIBER OPTIC FEEDTHROUGH FOR IMMERSION COOLING WITH CONDENSATE PREVENTION

(71) Applicant: 3M INNOVATIVE PROPERTIES COMPANY, St. Paul, MN (US)

(72) Inventors: Daniel J. Treadwell, Austin, TX (US); Stephen Paul LeBlanc, Austin, TX (US); Phillip E. Tuma, Faribault, MN (US)

(21) Appl. No.: 19/118,893

(22) PCT Filed: Oct. 19, 2023
(86) PCT No.: PCT/IB2023/060585

§ 371 Date: Apr. 7, 2025

Related U.S. Application Data
(60) Provisional application No. 63/419,109, filed on Oct. 25, 2022.

(51) Int. Cl. G02B 6/42

(52) U.S. Cl. CPC G02B 6/4266; G02B 6/4248

(57) ABSTRACT

An optical system includes a sealed enclosure partially filled with hot coolant defining a headspace above the coolant, a first optical connector disposed in the headspace, and a temperature regulating system. The first optical connector is attached to a first end of a first optical fiber, and an opposite second end of the first optical fiber is optically coupled to a first optical element. The first optical connector is configured to transmit light through the first optical fiber and an optical feedthrough coupled to a wall of the enclosure between the first optical element and a second optical element disposed outside the enclosure. At least a portion of the temperature regulating system is disposed in the headspace and is in thermal communication with the first optical connector for maintaining a temperature of at least the first optical connector sufficiently high to prevent condensation of the coolant on the optical connector.

### SUMMARY

In some aspects of the present description, an optical system is provided, the optical system including a sealed enclosure partially filled with an at least hot coolant defining a headspace above the coolant, a first optical connector disposed in the headspace of the enclosure, and a temperature regulating system. The first optical connector is attached to a first end of a first optical fiber, and an opposite second end of the first optical fiber optically coupled to a first optical element. The first optical connector is configured to transmit light through the first optical fiber and through an optical feedthrough coupled to a wall of the enclosure between the first optical element and a second optical element disposed outside the enclosure. At least a portion of the temperature regulating system is disposed in the headspace of the enclosure and is in thermal communication with the first optical connector for maintaining a temperature of at least the first optical connector sufficiently high to prevent a condensation of the coolant on the first optical connector.

In some aspects of the present description, an optical system is provided, the optical system including a sealed enclosure partially filled with an at least hot coolant defining a headspace thereabove, and first and second optical connectors substantially entirely disposed in the headspace of the sealed enclosure. The headspace includes at least one vapor. The first and second optical connectors are attached to respective first and second optical fibers. A fiber end of one of the first and second optical fibers is optically terminated at a first optical element disposed inside the sealed enclosure. A fiber end of the other one of the first and second optical fibers is optically terminated at a second optical element disposed outside the sealed enclosure. Light propagating in one of the first and second optical fibers exits the corresponding one of the first and second optical connectors through an output spot of an output surface of the optical connector, and the light enters the other one of the first and second optical connectors through an input spot of an input surface of the other one of the first and second optical connectors. The input and output spots have temperatures greater than a condensation temperature of the at least one vapor.

### BRIEF DESCRIPTION OF THE DRAWINGS

FIG. 1 is a schematic view of an optical system with a fiber optic feedthrough, in accordance with an embodiment of the present description;

FIG. 2 is a schematic view of an optical system with a fiber optic feedthrough, in accordance with an alternate embodiment of the present description;

FIG. 3 is a schematic view of an optical system with a fiber optic feedthrough, in accordance with another alternate embodiment of the present description; and

FIG. 4 is a schematic view of first and second optical connectors disposed in a headspace of a sealed enclosure, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Heat generated in electrical devices can lead to premature component failure. One technique to cool electrical devices is to submerse them in a reservoir or tank containing a non-conductive liquid. One solution is the use of a closed, two-phase cooling system, where a low boiling point fluid is used as the cooling medium. In this example, the heat generated causes the liquid to turn into a vapor. Heat is then removed from the vapor and the vapor is condensed back to a liquid. To prevent the fluid/vapor from evaporating into the atmosphere, the reservoir or tank containing the fluid should be sealed. However, one challenge to overcome with this approach is getting electrical or optical signals out of the sealed system. Traditionally, feedthrough connections have been used to accomplish this task. A feedthrough has a connector on the inside of the tank and one on the outside of the tank. The two connectors are linked using wire or optical fiber that is passed through the tank wall or lid. A sealing material is placed on or around the wire/fibers at the tank wall or lid to prevent fluid/vapor loss.

In most configurations, the connectors inside the tank are placed in a cool vapor and air region called the “headspace.” This is the area above the boiling fluid and above the hot saturated vapor layer which can form. The headspace region provides an atmosphere for which most connectors are designed to operate.

In some instances, the connectors could become wet with the cooling fluid. For example, when the outside of the tank is cooled below the condensation point of the fluid, fluid droplets can begin to collect on the walls and cover of the tank. Fluid may also condense on the feedthrough.

Eventually this fluid will either form on the connectors or migrate onto the connectors after forming on nearby surfaces. When the fluid enters the connectors, their performance may beaffected. Condensed fluid can be detrimental to the performance of expanded beam optical connectors.

According to some aspects of the present description, an optical system includes a means to keep the connector temperature above the saturation vapor temperature by drawing heat from the heated coolant into the connectors. In some embodiments, such an optical system may include a sealed enclosure partially filled with an at least hot coolant defining a headspace above the coolant, a first optical connector disposed in the headspace, and a temperature regulating system. In some embodiments, the at least hot coolant may be at a temperature that is less than a boiling point of the coolant. In some embodiments, the at least hot coolant is a boiling coolant. In some embodiments, the coolant may include one or more of a perfluorocarbon (PFC), a hydrofluoroolefin (HFO), a hydrofluoroether (HFE), and a fluoroketone (FK).

In some embodiments, the first optical connector may be attached to a first end of a first optical fiber. In some embodiments, an opposite second end of the first optical fiber may be optically coupled to a first optical element. In some embodiments, the first optical connector may be configured to transmit light through the first optical fiber and an optical feedthrough coupled to a wall of the enclosure, between the first optical element and a second optical element disposed outside the enclosure.

In some embodiments, at least a portion of the temperature regulating system may be disposed in the headspace of the enclosure and in thermal communication with the first optical connector for maintaining a temperature of at least the first optical connector sufficiently high to prevent a condensation of the coolant on the first optical connector.

In some embodiments, any coolant in the headspace may be primarily in a vapor form. In some embodiments, the headspace may include one or more of the coolant in a vapor form, air, and water vapor.

In some embodiments, the sealed enclosure may not include a saturated space defined between the at least hot coolant and the headspace. In some such embodiments, any coolant in the headspace may be primarily in a vapor form. In other such embodiments, the headspace may include one or more of the coolant in a vapor form, air, and water vapor. In other such embodiments, the boiling coolant and the headspace define a saturated space therebetween, the saturated space including a vapor of the coolant. In embodiments having the saturated space, less than about 10%, or less than about 7%, or less than about 5%, or less than about 4%, or less than about 3%, or less than about 2%, or less than about 1% of the first optical connector may be disposed in the saturated space. In other such embodiments, no portion of the first optical connector is disposed in the saturated space.

In some embodiments, the second end of the first optical fiber may be immersed in the at least hot coolant. In some embodiments, the first optical element may be immersed in the at least hot coolant. In some embodiments, the first optical element may be substantially entirely disposed in the headspace. In some embodiments, the first optical element may be electrically coupled to an electrical circuit at least partially immersed in the at least hot coolant.

In some embodiments, the temperature regulating system may include a thermally conductive element. In some embodiments, a first portion of the thermally conductive element may be disposed in the headspace of the enclosure and may be in thermal communication with the first optical connector. In some embodiments, a different second portion of the thermally conductive element may be immersed in the at least hot coolant. In some embodiments, the temperature regulating system may include an electrically resistive element electrically coupled to an electrical power source. In some such embodiments, at least a first portion of the electrically resistive element may be disposed in the headspace of the enclosure and in thermal communication with the first optical connector.

In some embodiments, when in operation, a pressure inside of the sealed enclosure may vary by no more than about 20%, or about 15%, or about 10%, or about 5%. In some embodiments, when in operation, the inside pressure may be about 1 atmosphere.

In some embodiments, the optical system may include a second optical connector disposed in the sealed enclosure and attached to a first end of a second optical fiber. In some embodiments, the second optical fiber may exit the sealed enclosure through the optical feedthrough so that an opposite second end of the second optical fiber is optically coupled to the second optical element. In some embodiments, light from one of the first and second optical elements may be transmitted to the other one of the first and second optical elements through the first and second optical connectors and the first and second optical fibers. In some such embodiments, light propagating in one of the first and second optical fibers may exit the corresponding one of the first and second optical connectors through an output spot of an output surface of the optical connector and may enter the other one of the first and second optical connectors through an input spot of an input surface of the other one of the first and second optical connectors. In some embodiments, the temperature regulating system may maintain the temperatures of the input and output spots above a condensation temperature of the coolant.

According to some aspects of the present description, an optical system may include a sealed enclosure partially filled with an at least hot coolant defining a headspace thereabove, the headspace comprising at least one vapor, and first and second optical connectors. The first and second optical connectors may be substantially entirely disposed in the headspace of the sealed enclosure and attached to respective first and second optical fibers. In some embodiments, a fiber end of one of the first and second optical fibers may be optically terminated at a first optical element disposed inside the sealed enclosure. In some embodiments, a fiber end of the other one of the first and second optical fibers may be optically terminated at a second optical element disposed outside the sealed enclosure. In some embodiments, light propagating in one of the first and second optical fibers may exit the corresponding one of the first and second optical connectors through an output spot of an output surface of the optical connector and may enter the other one of the first and second optical connectors through an input spot of an input surface of the other one of the first and second optical connectors. In some embodiments, the input and output spots may have temperatures greater than a condensation temperature of the at least one vapor. In some embodiments, each of the input and output spots are less than about 500 microns, or less than about 450 microns, or less than about 400 microns, or less than about 350 microns, or less than about 300 microns, or less than about 250 microns, or less than about 200 microns, or less than about 150 microns, or less than about 100 microns in diameter.

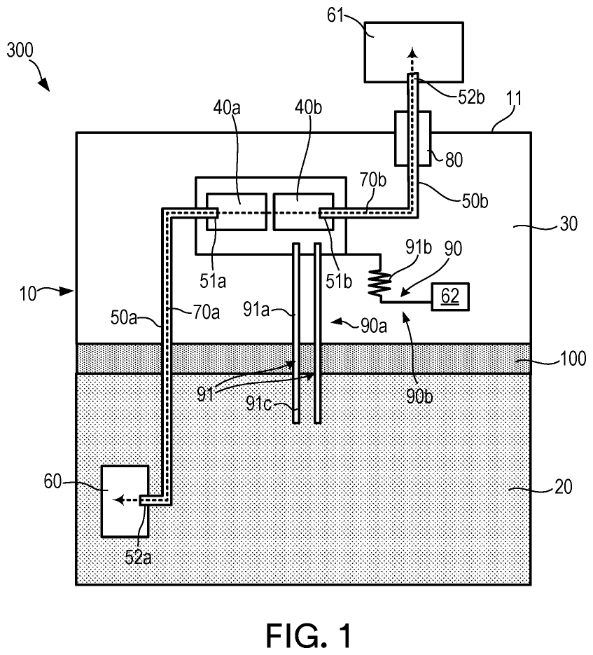

Turning now to the figures, FIG. 1 is a schematic view of one embodiment of an optical system with a fiber optic feedthrough, according to the present description. In some embodiments, optical system 300 may include a sealed enclosure 10, at least a first optical connector 40a, and a temperature regulating system 90a, 90b. In some embodiments, the sealed enclosure 10 may be at least partially filled with a coolant 20. In some embodiments, the coolant 20 may be at least a hot coolant (e.g., the coolant is at a temperature less than the boiling point of the coolant), and in some embodiments, the coolant 20 may be a boiling coolant. In some embodiments, the at least hot coolant 20 may define a headspace 30 above the coolant 20. In some embodiments, any of the coolant 20 in the headspace 30 is primarily in a vapor form. In some embodiments, the headspace 30 may include one or more of coolant in a vapor form, air, and water vapor.

In some embodiments, when in operation, a pressure inside of sealed enclosure 10 varies by no more than about 20%, or no more than about 15%, or no more than about 10%, or no more than about 5%. In some embodiments, when in operation, the inside pressure of sealed enclosure 10 is about 1 atmosphere.

In some embodiments, the hot coolant 20 (e.g., a boiling coolant 20) and the headspace 30 may define a saturated space 100 therebetween, such that the saturated space 100 includes a vapor of the coolant. In some embodiments, the first optical connector 40a and second optical connector 40 b are not disposed in the saturated space 100. In some embodiments, less than about 10%, or less than about 7%, or less than about 5%, or less than about 4%, or less than about 3%, or less than about 2%, or less than about 1% of either the first optical connector 40 a or second optical connector 40b may be disposed in saturated space 100. In some embodiments, the coolant may include one or more of a perfluorocarbon (PFC), a hydrofluoroolefin (HFO), a hydrofluoroether (HFE), and a fluoroketone (FK).

In some embodiments, the first optical connector 40a may be disposed in headspace 30. In some embodiments, first optical connector 40a may be attached to a first end 51a of a first optical fiber 50a. In some embodiments, an opposite, second end 52a of first optical fiber 50a may be optically coupled to a first optical element 60. In some embodiments, first optical element 60 may be immersed partially or entirely in the at least hot coolant 20. In some embodiments, second end 52a of first optical fiber 50a may be immersed in the at least hot coolant 20.

In some embodiments, optical system 300 may further include a second optical connector 40b disposed in the sealed enclosure 10 and attached to a first end 51b of a second optical fiber 50b. In some embodiments, the second optical fiber 50b may exit the sealed enclosure through optical feedthrough 80 so that an opposite second, end 52b of the second optical fiber 50b is optically coupled to a second optical element 61. In some embodiments, light 70a, 70b from one of the first 60 and second 61 optical elements may be transmitted to the other one of the first 60 and second 61 optical elements through the first 40a and second 40b optical connectors and the first 50a and second 50b optical fibers. In some embodiments, first optical connector 40a and second optical connector 40b may be connected by a mating sleeve, an adapter, or other appropriate physical mating means. In some embodiments, at least one of the first optical connector 40a and second optical connector 40b may be an expanded beam optical fiber connectors. In some embodiments, at least one of the first optical connector 40a and second optical connector 40b may be multi-fiber optical connectors.

In some embodiments, the temperature regulating system 90a may include at least one thermally conductive element 91, wherein a first portion 91a of the thermally conductive element 91 is disposed in the headspace 30 of enclosure 10 and in thermal communication with the at least first optical connector 40a (and, when present, second optical connector 40b), and a different second portion 91c of thermally conductive element 91 is immersed in the at least hot coolant 20. In some embodiments, the temperature regulating system 90b may include an electrically resistive element 90 electrically coupled to an electrical power source 62, wherein at least a first portion 91b of the electrically resistive element 90 is disposed in the headspace of the enclosure and in thermal communication with the first optical connector 40a (and, when present, second optical connector 40b). In some embodiments, the electrical power source 62 may be disposed inside or outside of enclosure 10.

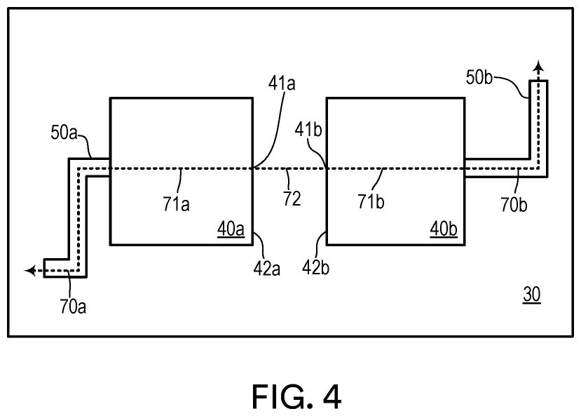

In some embodiments, at least a portion 91a, 91b of temperature regulating system 90a, 90b may be disposed in the headspace 30 of enclosure 10 and in thermal communication with at least the first optical connector 40a for maintaining a temperature of the at least first optical connector 40a sufficiently high to prevent a condensation of the coolant 20 on the at least first optical connector 40a. In some embodiments, the at least a portion 91a, 91b of temperature regulating system 90a, 90b may be in thermal communication with second optical connector 40b. Turning briefly to FIG. 4, which provides additional detail and should be examined with FIG. 1 for this discussion, in some embodiments, wherein light 70a, 70b propagating in one of the first 50a and second 50b optical fibers exits the corresponding one of the first 40a and second 40b optical connectors through an output spot 41a of an output surface 42a of the optical connector and enters the other one of the first 40a and second 40b optical connectors through an input spot 41b of an input surface 42b of the other one of the first 40a and second 40b optical connectors, the temperature regulating system 90a, 90b (see FIG. 1) may maintain temperatures of the input 41b and output 41a spots above a condensation temperature of coolant 20. In some embodiments, each of the input 41 b and output 41 a spots may be less than about 500 microns, or less than about 450 microns, or less than about 400 microns, or less than about 350 microns, or less than about 300 microns, or less than about 250 microns, or less than about 200 microns, or less than about 150 microns, or less than about 100 microns in diameter.

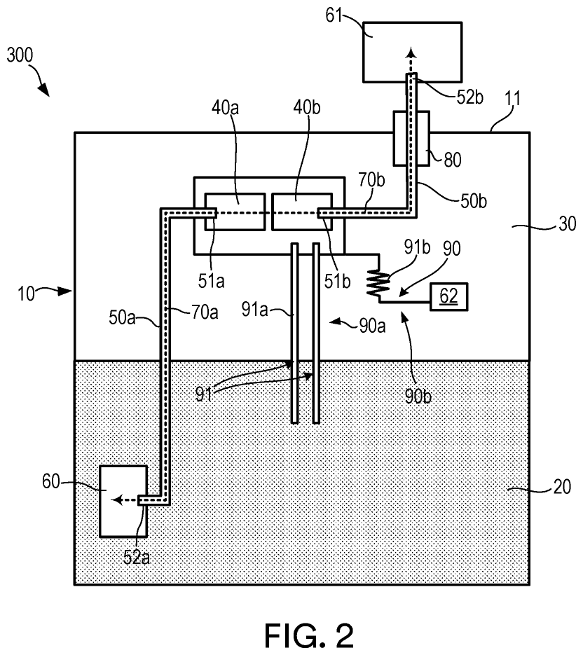

FIG. 2 provides an alternate embodiment of the optical system 300 of FIG. 1. The embodiment of optical system 300 of FIG. 2 shares many of the same elements of optical system 300 of FIG. 1, and the elements of FIG. 2 shall be assumed to have the same function as their like-numbered elements in FIG. 1, unless explicitly stated otherwise herein. A primary difference between the embodiment shown in FIG. 1 and the embodiment shown here in FIG. 2 is that optical system 300 of FIG. 2 does not include the saturated space 100 defined between the at least hot coolant 20 and headspace 30.

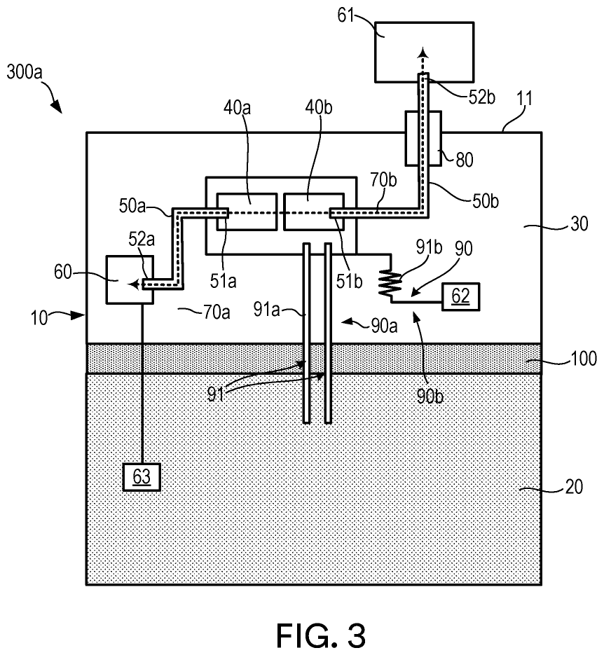

FIG. 3 provides another alternate embodiment of the optical system 300 of FIG. 1. The embodiment of optical system 300 of FIG. 3 shares many of the same elements of optical system 300 of FIG. 1, and the elements of FIG. 3 shall be assumed to have the same function as their like-numbered elements in FIG. 1, unless explicitly stated otherwise herein. A primary between the embodiment shown in FIG. 1 and the embodiment shown here in FIG. 3 is that first optical element 60 is substantially entirely disposed in headspace 30 rather than in coolant 20. In such embodiments, the first optical element 60 may be electrically coupled to an electrical circuit 63 which may be at least partially immersed in the at least hot coolant 20.

FIG. 4 is a schematic view of an embodiments of first and second optical connectors disposed in a headspace of a sealed enclosure, the details of which are discussed elsewhere herein.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optical system comprising:
a sealed enclosure partially filled with an at least hot coolant defining a headspace above the coolant;
a first optical connector disposed in the headspace of the enclosure and attached to a first end of a first optical fiber, an opposite second end of the first optical fiber optically coupled to a first optical element, the first optical connector configured to transmit light, through the first optical fiber and an optical feedthrough coupled to a wall of the enclosure, between the first optical element and a second optical element disposed outside the enclosure; and
a temperature regulating system at least a portion of which is disposed in the headspace of the enclosure and in thermal communication with the first optical connector for maintaining a temperature of at least the first optical connector sufficiently high to prevent a condensation of the coolant on the first optical connector.

2. The optical system of claim 1, wherein the at least hot coolant comprises a temperature less than a boiling point of the coolant.

3. The optical system of claim 2, wherein any of the coolant in the headspace is primarily in a vapor form.

4. The optical system of claim 2, wherein the headspace comprises one or more of the coolant in a vapor form, air, and water vapor.

5. The optical system of claim 2, wherein the sealed enclosure does not comprise a saturated space (100) defined between the at least hot coolant and the headspace.

6. The optical system of claim 1, wherein the at least hot coolant is a boiling coolant.

7. The optical system of claim 6, wherein any of the coolant in the headspace is primarily in a vapor form.

8. The optical system of claim 6, wherein the headspace comprises one or more of the coolant in a vapor form, air, and water vapor.

9. The optical system of claim 6, wherein the boiling coolant and the headspace define a saturated space therebetween, the saturated space comprising a vapor of the coolant.

10. The optical system of claim 9, wherein less than about 10% of the first optical connector is disposed in the saturated space.

11. The optical system of claim 9, wherein no portion of the first optical connector is disposed in the saturated space.

12. The optical system of claim 1, wherein the coolant comprises one or more of a perfluorocarbon, a hydrofluoroolefin, a hydrofluoroether, and a fluoroketone.

13. The optical system of claim 1, wherein the second end of the first optical fiber is immersed in the at least hot coolant.

14. The optical system of claim 1, wherein the first optical element is immersed in the at least hot coolant.

15. The optical system of claim 1, wherein the first optical element is substantially entirely disposed in the headspace.

16. The optical system of claim 15, wherein the first optical element is electrically coupled to an electrical circuit at least partially immersed in the at least hot coolant.

17. The optical system of claim 1, wherein the temperature regulating system comprises a thermally conductive element, wherein a first portion of the thermally conductive element is disposed in the headspace of the enclosure and in thermal communication with the first optical connector, and a different second portion of the thermally conductive element is immersed in the at least hot coolant.

18. The optical system of claim 1, wherein the temperature regulating system comprises an electrically resistive element electrically coupled to an electrical power source, wherein at least a first portion of the electrically resistive element is disposed in the headspace of the enclosure and in thermal communication with the first optical connector.

19. The optical system of claim 1, wherein when in operation, a pressure inside of the sealed enclosure varies by no more than about 20%.

20. The optical system of claim 19, wherein when in operation, the inside pressure is about 1 atmosphere.

21.-26. (canceled)
